(19) United States
(12) Patent Application Publication
(10) Pub. No.: US 2021/0406043 A1
(43) Pub. Date: Dec. 30, 2021

(54) TERMINAL DEVICE, SCREEN DISPLAY SYSTEM, DISPLAY METHOD, AND PROGRAM

(71) Applicant: MERCARI, INC., Tokyo (JP)

(72) Inventor: Yusuke SHIBUI, Tokyo (JP)

(21) Appl. No.: 17/361,080

(22) Filed: Jun. 28, 2021

(30) Foreign Application Priority Data
Jun. 30, 2020 (JP) 2020-113368

(51) Int. Cl. G06F 9/451; G06N 5/04; G06N 20/00

(52) U.S. Cl. CPC G06F 9/451; G06N 20/00; G06N 5/04

(57) ABSTRACT

A terminal device used by a user includes a display, a memory; and a processor configured to execute inferring a layout of a screen optimized for the user, and displaying the screen with the inferred layout on the display.

### CROSS-REFERENCE TO RELATED APPLICATIONS

The present application is based on and claims the benefit of priority of Japanese Priority Application No. 2020-113368, filed on Jun. 30, 2020, the entire contents of which are hereby incorporated by reference.

### TECHNICAL FIELD

The present disclosure relates to a terminal device, a screen display system, a display method, and a program.

### BACKGROUND ART

Terminal devices that change the brightness of a screen or display contents depending on the environment of the surroundings such as a period of time of a day, lighting, and the like, have been known.

For example, Japanese Unexamined Patent Application Publication No. 2007-041641 discloses a mobile terminal device in which one day is partitioned into multiple periods of time, and a display unit changes the tone of a background image depending on the period of time to which the current time belongs.

However, in the conventional technique, even if the environment of the surroundings is the same, in the case where the behavioral pattern and the situation differ from user to user, screens suitable for the respective users cannot be displayed.

### SUMMARY

A terminal device according to one embodiment in the present disclosure is a. terminal device used by a user, and has, for example, the following configuration; namely, the terminal device includes a display; a memory; and a processor configured to execute inferring a layout of a screen optimized for the user, and displaying the screen with the inferred layout on the display.

### BRIEF DESCRIPTION OF DRAWINGS

FIG. 1 is a diagram illustrating an example of a system configuration of a display system;

FIG. 2 is a diagram illustrating an example of a hardware configuration of a server device;

FIG. 3 is a diagram illustrating an example of a hardware configuration of a terminal device;

FIG. 4 is a diagram illustrating an example of functional units of a server device and a terminal device;

FIG. 5 is a diagram illustrating an example of situation data;

FIG. 6 is a diagram illustrating an example of operation log data;

FIG. 7 is a diagram illustrating an example of a flow of a process of obtaining situation data;

FIG. 8 is a diagram illustrating an example of a flow of processing executed by a server device;

FIG. 9.A is a first diagram illustrating an example of a layout of a screen presenting a result of item search;

FIG. 9B is a second diagram illustrating an example of a layout of a screen presenting a result of item search;

FIG. 9C is a third diagram illustrating an example of a layout of a screen presenting a result of item search;

FIG. 9D is a fourth diagram illustrating an example of a layout of a screen presenting a result of item search;

FIG. 10A is a first diagram illustrating an example of a layout common to all screens;

FIG. 10B is a second diagram illustrating an example of a layout common to all screens;

FIG. 10C is a third diagram illustrating an example of a layout common to all screens;

FIG. 10D is a fourth diagram illustrating an example of a layout common to all screens;

FIG. 11 is a diagram illustrating an example of a flow of an initial screen display process;

FIG. 12 is a diagram illustrating an example of a flow of an operation receiving process;

FIG. 13 is a diagram illustrating an example of a flow of a screen layout change process; and

FIG. 14 is a diagram illustrating an example of a flow of a learning process.

### DESCRIPTION OF EMBODIMENTS

In the following, embodiments in the present disclosure will be described with reference to the drawings.

According to the present disclosure, screens suitable for respective users can be displayed.

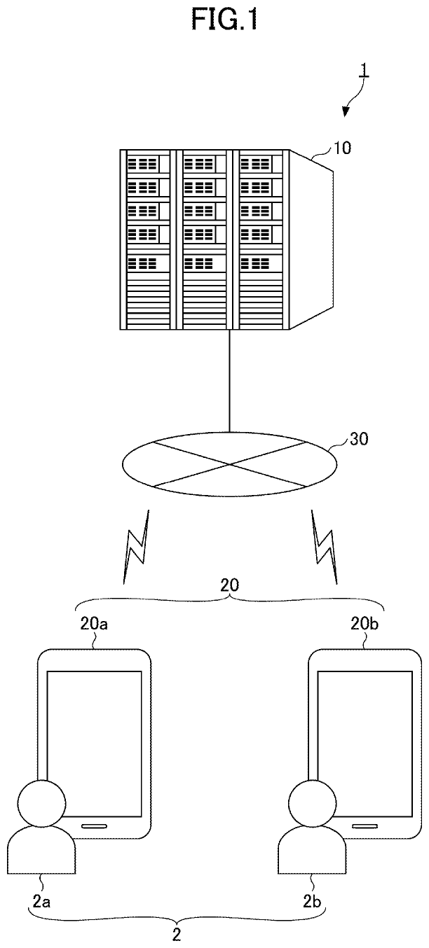

FIG. 1 is a diagram illustrating an example of a system configuration of a display system.

The screen display system 1 includes a server device 10 and terminal devices 20. The server device 10 and the terminal devices 20 are communicably connected via a network 30.

The server device 10 is an information processing device that transmits various items of data to be displayed on the screen of the terminal device 20 to the terminal device 20, in response to a request from the terminal device 20.

The terminal device 20 is a generic term for a terminal device 20a carried and used by a user 2a, a terminal device 20b carried and used by a user 2b, and the like, and is a device that is carried and used by an individual user. In the terminal device 20, application programs for implementing various functions such as electronic commerce, electronic settlement, and the like are installed. The terminal device 20 requests the server device 10 to transmit data according to a function, and displays a screen based on data transmitted in response.

In the following, although the present embodiment will be described with an example of electronic commerce, the function implemented in the terminal device 20 is not limited as such, and any other functions can be adopted as long as the function accompanies screen displaying.

Next, the hardware configuration of the respective devices will be described.

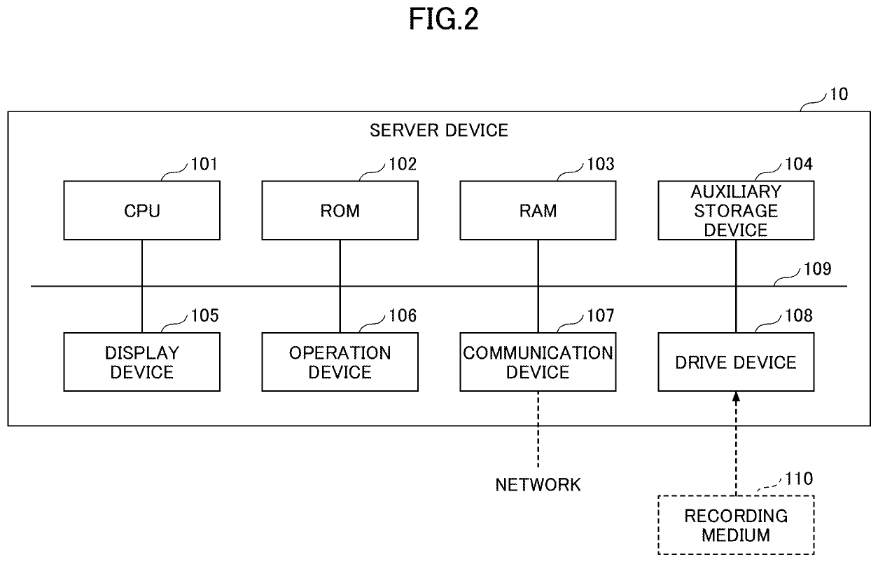

FIG. 2 is a diagram illustrating an example of a hardware configuration of the server device 10.

The server device 10 is constituted with a computer, and includes a CPU (Central Processing Unit) 101, a ROM (Read-Only Memory) 102, a RAM (Random Access Memory) 103, an auxiliary storage device 104, a display device 105, an operation device 106, a communication device 107, and a drive device 108. The hardware components of the server device 10 are mutually connected via a bus 109,

The CPU 101 reads a program stored in the ROM 102 or the auxiliary storage device 104, to store the program in the RAM 103. Then, the CPU 101 executes various processes as will be described later, according to the program stored in the RAM 103. Also, the CPU 101 has a timer circuit, and holds data that represents date, time, and the like.

The ROM 102 is a non-volatile auxiliary storage device. The ROM 102 stores a program that specifies basic operations of the server device 10, such as BIOS.

The RAM 103 is a volatile main memory device. The RAM 103 is used as a working area of the CPU 101.

The auxiliary storage device 104 stores various programs and various items of data used for processing executed by the CPU 101.

The display device 105 is a display device that displays various items of information of the server device 10. The operation device 106 is an input device used by an administrator of the server device 10 to input various commands into the server device 10. The communication device 107 is a communication device that establishes connection with the network 30, to communicate with the terminal device 20 and the like.

The drive device 108 is a device for setting a recording medium 110. The recording medium 110 here includes media that optically, electrically, or magnetically record information, such as a CD-ROM, a flexible disk, a magneto-optical disk, and the like. Also, the recording medium 110 may include a semiconductor memory or the like that electrically records information, such as a ROM, a flash memory, and the like.

Note that various programs to be installed in the auxiliary storage device 104 are installed by, for example, setting a distributed recording medium 110 in the drive device 108 and reading the various programs recorded on the recording medium 110 by the drive device 108. Alternatively, various programs to be installed in the auxiliary storage device 104 may be installed by downloading from the network 30 via the communication device 107.

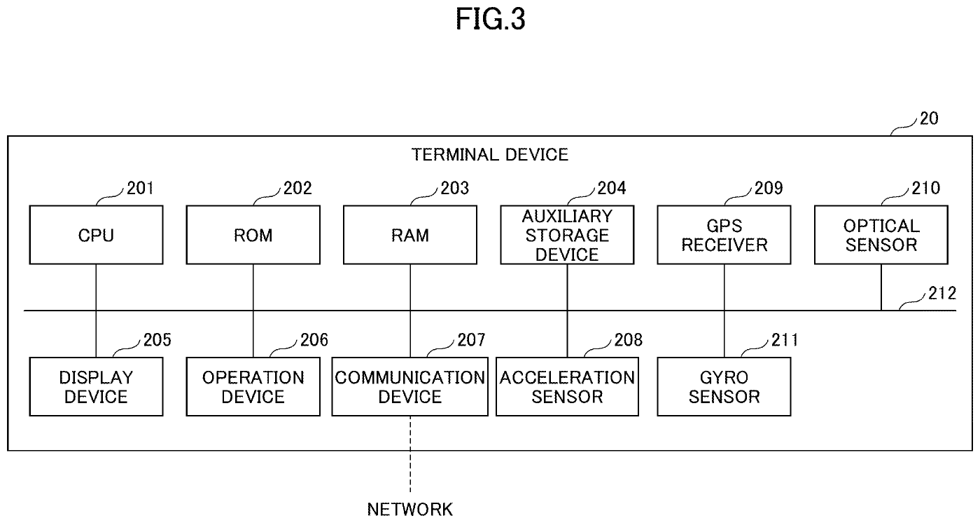

FIG. 3 is a diagram illustrating an example of a hardware configuration of the terminal device 20.

The terminal device 20 is constituted with a computer, and includes a CPU (Central Processing Unit) 201, a ROM (Read-Only Memory) 202, a RAM (Random Access Memory) 203, an auxiliary storage device 204, a display device 205, an operation device 206, a communication device 207, an acceleration sensor 208, a GPS (Global Positioning System) receiver 209, an optical sensor 210, and a gyro sensor 211. Note that the hardware components of the terminal device 20 are mutually connected via a bus 212.

As illustrated in FIG. 3, the hardware components of the terminal device 20 include substantially the same hardware components as those of the server device 10 illustrated in FIG. 2; therefore, differences from the server device 10 will be mainly described here.

The acceleration sensor 208 is a device to measure acceleration. The CPU 201 calculates the traveling speed of the user who is carrying the terminal device 20, based on acceleration measured by the acceleration sensor 208.

The GPS receiver 209 is a device to receive radio waves transmitted by GPS satellites. The GPS is a system that uses satellites to precisely determine the location at which oneself is on the earth. The CPU 201 calculates the position (latitude, longitude, and the like) of the user who is carrying the terminal device 20, based on radio waves received by the GPS receiver 209.

The optical sensor 210 is a device to measure the intensity of light. The CPU 201 calculates brightness when the user browses around with the terminal device 20, based on the intensity of light measured by the optical sensor 210.

The gyro sensor 211 is a device to measure angular velocity. The CPU 201 calculates the direction of the terminal device 20, based on the angular velocity measured by the gyro sensor 211.

Note that the acceleration sensor 208, the GPS receiver 209, the optical sensor 210, and the gyro sensor 211 function as devices to obtain situation data that indicates a situation of the user. The devices provided on the terminal device 20 for obtaining situation data are not limited to these, and may include other devices, for example, a temperature sensor, a pressure sensor, and the like.

Next, functional units of each device will be described.

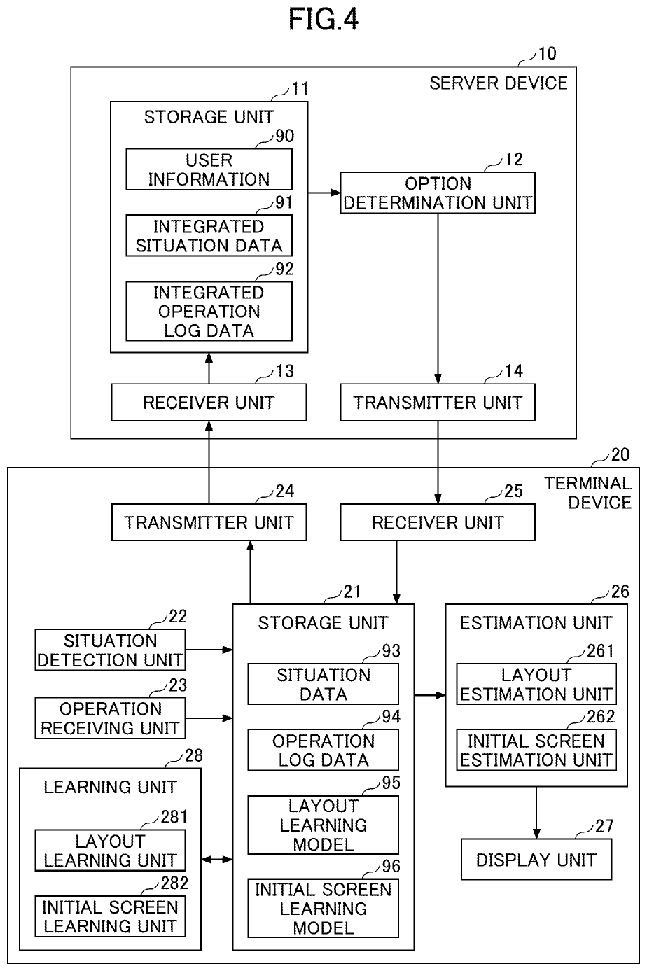

FIG. 4 is a diagram illustrating an example of functional units of a server device and a terminal device.

The server device 10 includes a storage unit 11, an option determination unit 12, a receiver unit 13, and a transmitter unit 14.

The storage unit 11 stores various items of data. Specifically, the storage unit 11 stores user information 90, integrated situation data 91, and integrated operation log data 92. The storage unit 11 is implemented by a ROM 102 or an auxiliary storage device 104.

The user information 90 is information that represents each user who carries the terminal device 20. The user information 90 includes, as fields, a user ID as an identifier for identifying the user, a user group that represents classification of users, and the like. User groups are categorized according to various criteria that includes age, gender, address, nationality, occupation, and the like.

The integrated situation data 91 is data in which the situation data 93 received by the receiver unit 13 from the respective terminal devices 20 is integrated. The integrated operation log data 92 is data in which the operation log data 94 received by the receiver unit 13 from the respective terminal devices 20 is integrated. Examples of the integrated situation data 91 and the integrated operation log data 92 will be described later.

Based on the integrated situation data 91 and the integrated operation log data 92, the option determination unit 12 determines options of layouts and initial screens optimized for the respective user groups that represent classification of the users. The option determination unit 12 is implemented by the CPU 101.

The layout according to the present embodiment is not limited to a method of arranging contents within a screen, but refers to a display method of a screen including the brightness of the screen, the background color, and contents to be displayed. Changing contents to be displayed depending on a situation means changing items or contents to be displayed depending on the situation as in, for example, items that the user does not want to display while on the move, or contents that the user wants to display while going out.

For example, based on the situation data and the operation log data of users who belong to a user group of “age=20 to 29 years”, “gender=female”, and classified by the occupation, once having inferred that the users are more likely to use a function of purchasing an item than a function of listing an item, the option determination unit 12 includes an item search screen in options of the initial screen of the user group of “age=20 to 29 years” and “gender=female”.

The receiver unit 13 receives various items of information from the terminal device 20. Specifically, the receiver unit 13 receives the situation data 93 and the operation log data 94 from the terminal device 20.

The transmitter unit 14 transmits various items of information to the terminal device 20. Specifically, the transmitter unit 14 transmits data that represents options of layouts and options of initial screens determined by the option determination unit 12 to the terminal device 20.

The receiver unit 13 and the transmitter unit 14 are implemented by the communication device 107.

The terminal device 20 includes a storage unit 21, a situation detection unit 22, an operation receiving unit 23, a transmitter unit 24, a receiver unit 25, an estimation unit 26, a display unit 27, and a learning unit 28.

The storage unit 21 stores various items of information. Specifically, the storage unit 21 stores situation data 93, operation log data 94, a layout learning model 95, and an initial screen learning model 96. The storage unit 21 is implemented by the ROM 102 or the auxiliary storage device 204.

The situation data 93 is data that represents the situation of the user detected by the situation detection unit 22. Specifically, the situation of the user includes data that represents date, period of time of a day, behavior, location, environment, and the like, though not limited as such.

The operation log data 94 is data that represents operations of the user that have been received by the operation receiving unit 23. For example, the operations of the user include an operation of entering characters as a search condition on an item search screen; an operation of pressing a button; an operation of slow scrolling on an item screen; an operation of selecting an item; an operation of purchasing an item after long reading; and the like,

The layout learning model 95 is data that specifies an algorithm executed by the layout estimation unit 261 to infer a layout optimized for the user. Given the situation data 93 and the operation log data 94 as input parameters, the layout learning model 95 outputs information that represents an optimized layout.

The initial screen learning model 96 is data that specifies an algorithm executed by the initial screen estimation unit 262 to infer an initial screen optimized for the user. Given the situation data 93 and the operation log data 94 as input parameters, the initial screen learning model 96 outputs information that represents an optimized initial screen.

Note that the algorithms of the layout learning model 95 and the initial screen learning model 96 include, for example, decision trees, support vector machines, logistic regression, linear regression, neural networks, deep learning, and the like, though not limited as such.

The situation detection unit 22 detects data that represents a situation of the user. The situation detection unit 22 stores the detected data as the situation data 93 in the storage unit 21. The situation detection unit 22 is implemented by the CPU 201, the acceleration sensor 208, the GPS receiver 209, the optical sensor 210, and/or the gyro sensor 211.

Note that the date and the period of time of the day are detected based on data that represents the date and time held in the timer circuit included in the CPU 201. The CPU 201 may update the date and time based on radio waves received by the communication device 207 from a base station or the like.

The operation receiving unit 23 receives an operation from the user. The operation receiving unit 23 stores data that represents a history of received operations as the operation log data 94 in the storage unit 21. The operation receiving unit 23 is implemented by the operation device 206.

The transmitter unit 24 transmits various items of information to the server device 10. Specifically, the transmitter unit 24 transmits the situation data 93 and the operation log data 94 to the server device 10.

The receiver unit 25 receives various items of information from the server device 10. Specifically, the receiver unit 25 receives data that represents options of layouts and initial screens on the screen. The receiver unit 25 stores the received data in the storage unit 21.

The estimation unit 26 includes a layout estimation unit 261 and an initial screen estimation unit 262. The estimation unit 26 is implemented by the CPU 101.

The layout estimation unit 261 infers a layout of a screen optimized for the user, Specifically, the layout estimation unit 261 gives data included in the situation data 93 and the operation log data 94, and data that represents options of layouts as input parameters to the layout learning model 95, to determine a layout of an optimized screen from among the options.

The initial screen estimation unit 262 infers an initial screen optimized for the user. Specifically, the initial screen estimation unit 262 gives data included in the situation data 93 and the operation log data 94, and data that represents options of initial screens as input parameters to the initial screen learning model 96, to determine an optimized initial screen of the screen from among the options.

The display remit 27 displays a screen. Specifically, the display unit 27 displays a screen with an inferred layout. Also, when displaying an initial screen, the display unit 27 displays the selected initial screen. Note that in the case where there are options of layouts for a screen selected as the initial screen, the display unit 27 displays the initial screen with an inferred layout. The display unit 27 is implemented by the display device 205.

The learning unit 28 includes a layout learning unit 281 and an initial screen learning unit 282. The learning unit 28 is implemented by the CPU 101.

The layout learning unit 281 updates the layout learning model 95 by a method of machine learning and statistical aggregation.

The initial screen learning unit 282 updates the initial screen learning model 96 by a method of machine learning and statistical aggregation.

Machine learning is a technique for causing a computer to acquire learning ability like human beings, and is a technique in which a computer autonomously generates an algorithm necessary for determination of data identification from training data loaded in advance, and applies the algorithm to new data to make predictions. The learning method for machine learning may be any one of supervised learning, unsupervised learning, semi-supervised learning, reinforced learning, and deep learning, and further, may be a combination of these learning methods.

Note that the learning unit 28 may use, as the training data, the situation data 93 obtained by the situation detection unit 22 and the operation log data 94 obtained by the operation receiving unit 23 after having displayed a selected layout or initial screen.

Next, data used in the screen display system 1 will be described,

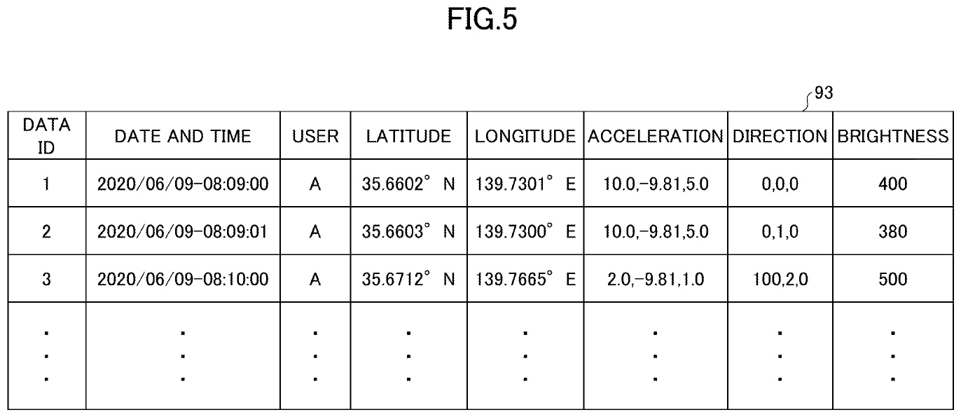

FIG. 5 is a diagram illustrating an example of situation data.

The situation data 93 includes, as fields, data ID, date and time, user, latitude, longitude, acceleration, direction, and brightness. However, these fields of the situation data 93 are examples, and are not limited as such.

The value of the field “data ID” is an identifier to identify a record of the situation data 93. A record is uniquely identified for each combination of date and time and a user.

The value of the field “date and time” is a value that represents the date and time at which data that represents a situation was detected. The value of the field “date and time” is used as original data of, for example, season, month, day of week, period of time of the day, and the like.

The value of the field “user” is a user ID for identifying the user.

The value of the field “latitude” is a value that represents the latitude of the terminal device 20.

The value of the field “longitude” is a value that represents the longitude of the terminal device 20.

The values of the field “latitude” and the field “longitude” are values obtained from radio waves received by the GPS receiver 209. The values of the field “latitude” and the field “longitude” are used as original data of, for example, position, traveling speed, and the like.

The value of the field “acceleration” is a value that represents the acceleration of the terminal device 20. The acceleration of the terminal device 20 is a value that represents three-dimensional acceleration and is a combination of triaxial values on the x, y, and z axes. The value of the field “acceleration” is used as original data of traveling speed, swaying, and the like.

The value of the field “direction” is a value that represents the direction of the terminal device 20. For example, the value of the field “direction” is a value that represents a direction along an axis perpendicular to a plane that includes the screen of the display device 205 of the terminal device 20. The direction of the terminal device 20 is a value that represents a three-dimensional direction and is a combination of triaxial values on the x, y, and z axes. The value of the field “direction” is used as original data of swaying and the like.

The value of the field “brightness” is a value that represents the brightness of light illuminating the terminal device 20. The value of the field “brightness” is used as original data of brightness and the like.

Note that the integrated situation data 91 also includes fields similar to those of the situation data 93. However, the value of the field “user” may be stored for each terminal device 20, and in this case, the field “user” does not need to be included in the situation data 93.

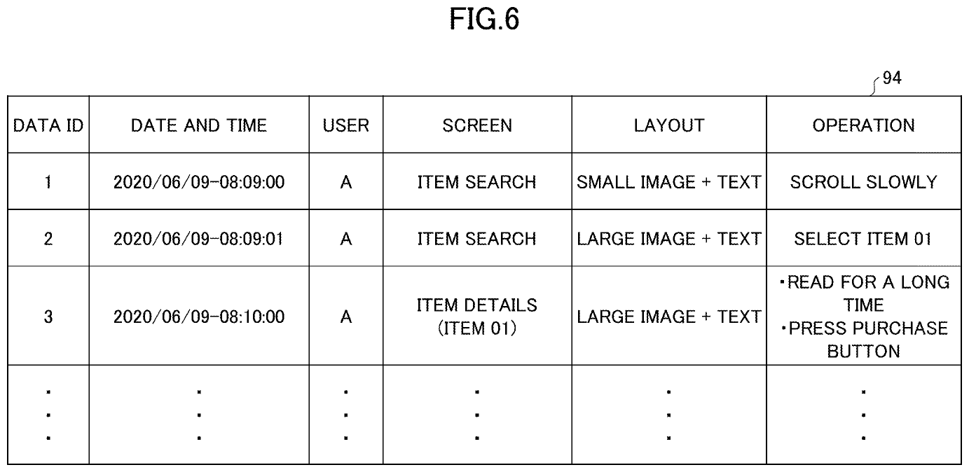

FIG. 6 is a diagram illustrating an example of operation log data.

The operation log data 94 includes, as fields, data ID, date and time, user, screen, layout, and operation. However, these fields of the operation log data 94 are examples, and are not limited as such.

The value of the field “data ID” is an identifier to identify a record of the operation log data 94. A record is uniquely identified for each combination of date and time and a user,

The value of the field “date and time” is a value that represents the date and time at which an operation was received.

The value of the field “user” is a user ID for identifying the user.

The value of the field “screen” is a value that represents a screen on which the user performed an operation.

The value of the field “layout” is a value that represents a layout of the screen when the user performed an operation.

The value of the field “operation” is a value that represents contents of the operation performed by the user,

Note that the integrated operation log data 92 also includes fields similar to those in the operation log data 94. However, the value of the field “user” may be stored for each terminal device 20, and in this case, the field “user” does not need to be included in the operation log data 94.

Next, operations of the screen display system 1 will be described.

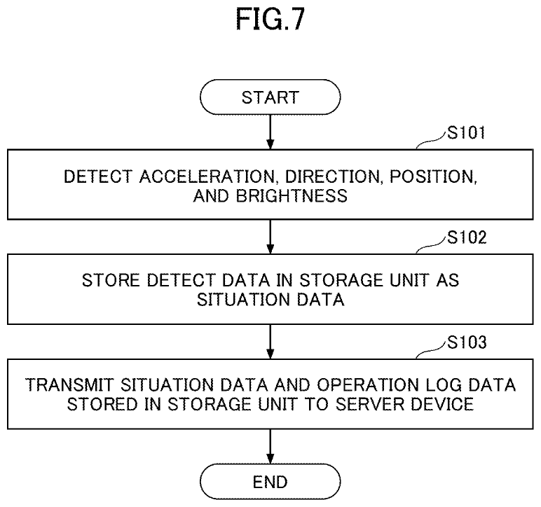

FIG. 7 is a diagram illustrating an example of a flow of a process of obtaining situation data.

The terminal device 20 executes the process of obtaining situation data regularly, for example, every minute. Once the terminal device 20 has started the process of obtaining situation data, the situation detection unit 22 detects the acceleration, direction, position, and brightness, at Step S101. Note that data items detected by the situation detection unit 22 are not limited as such, and other data items such as temperature, pressure, revolving speed, and the like may be detected.

Next, the situation detection unit 22 stores the detected data as the situation data 93 in the storage unit 21, at Step S102.

Next, the transmitter unit 24 transmits the situation data 93 and the operation log data 94 stored in the storage unit 21 to the server device 10, at Step S103. Note that the operation log data 94 is stored in the storage unit 21 by an operation receiving process that will be described later.

In response to receiving the situation data 93 and the operation log data 94 from the terminal device 20, the receiver unit 13 of the server device 10 stores the received data in the storage unit 11.

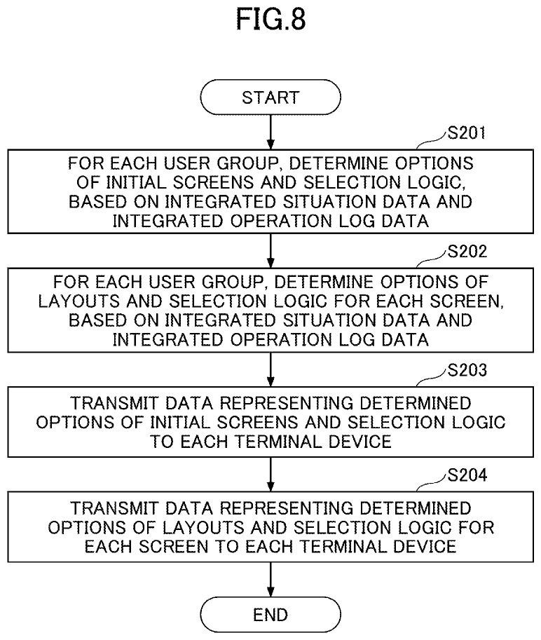

FIG. 8 is a diagram illustrating an example of a flow of processing executed by a server device.

The server device 10 executes processing illustrated in FIG. 8 regularly or in response to a request from the terminal device 20.

The option determination unit 12 of the server device 10 determines options of initial screens and selection logic, based on the integrated situation data 91 and the integrated operation log data 92 for each user group, at Step S201. For example, options to be determined include a search screen, a campaign screen, a coupon screen, a listing screen, an item screen browsed most recently, a saved search screen, an electronic settlement screen, and the like.

Also, the selection logic is data that represents, for example, a rule for determining a screen to be selected based on the date and time. For example, the selection logic includes the following rules: select a search screen or a campaign screen in the case of weekday morning; select a search screen or a coupon screen in the case of weekday afternoon; select a search screen,a listing screen, a campaign screen, a coupon screen, or an item screen browsed most recently in the case of weekday night; and select a search screen, a listing screen, a campaign screen, a coupon screen, or a saved search screen in the case of a holiday morning.

Next, the option determination unit 12 determines options of layouts and selection logic for each screen, based on the integrated situation data 91 and the integrated operation log data 92 for each user group, at Step S202.

The transmitter unit 14 transmits data that represents the determined options of initial screens and selection logic to each terminal device 20, at Step S203.

Next, the transmitter unit 14 transmits data that represents the determined options of layouts and selection logic for each screen to each terminal device 20, at Step S204. Note that layouts of each screen may include layouts specific to the screen and layouts common to all the screens.

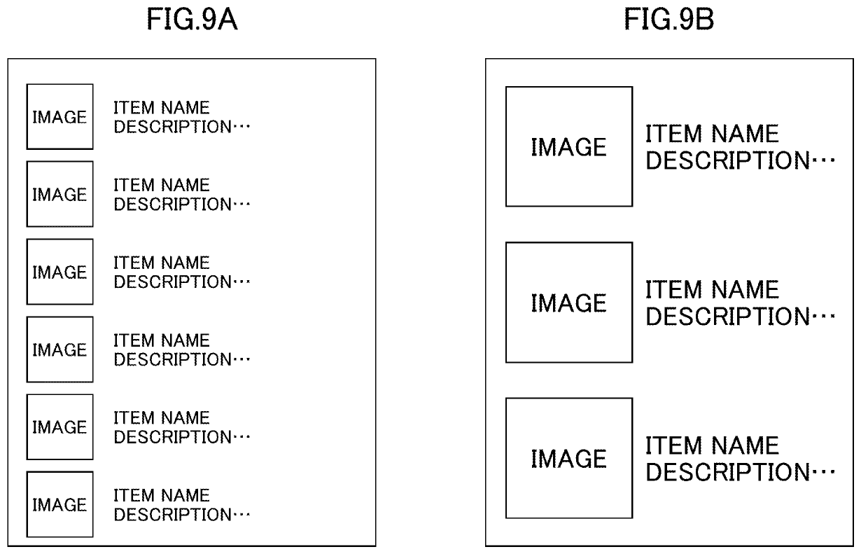

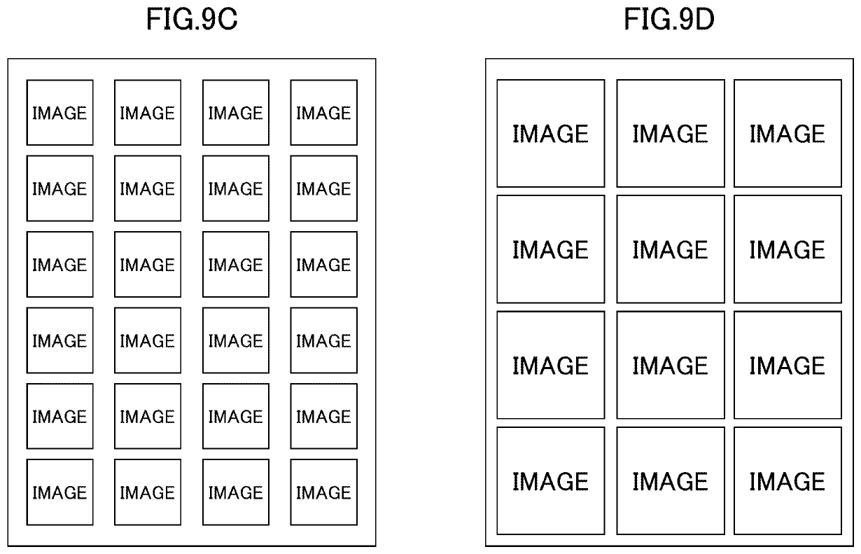

Each of FIGS. 9A to 9D is a diagram illustrating an example of a layout of an item screen.

At Step S204 described above, options of layouts transmitted to the terminal device 20 include, for example, as layouts of an item screen, the following layouts: a layout in which small images, item names, and descriptions are displayed as illustrated in FIG. 9A; a layout in which large images, item names, and descriptions are displayed as illustrated in FIG. 9B; a layout in which only small images are arranged vertically and horizontally as illustrated in FIG. 9C; and a layout in which only large images are arranged vertically and horizontally as illustrated in FIG. 9D.

The selection logic of a layout of an item screen is, for example, a rule of selecting a layout in which only large images are arranged vertically and horizontally as illustrated in FIG. 9D in the case where the user is on the move, because the screen cannot be browsed stably compared to the case of the user being at home.

More specifically, the selection logic of a layout of an item screen may include, for example, the following rules: select a layout as illustrated in FIG. 9A in the case of (weekday morning or weekday afternoon) and (on the move by a vehicle) and (being relaxed); select a layout as illustrated in FIG. 913 in the case of (weekday morning) and (on the move on foot or by a vehicle); select a layout as illustrated in FIG. 9C in the case of (any time) and (on the move on foot); or select a layout as illustrated in FIG. 9D in the case of (any time) and (on the move on foot, or on the move by a vehicle, or being relaxed).

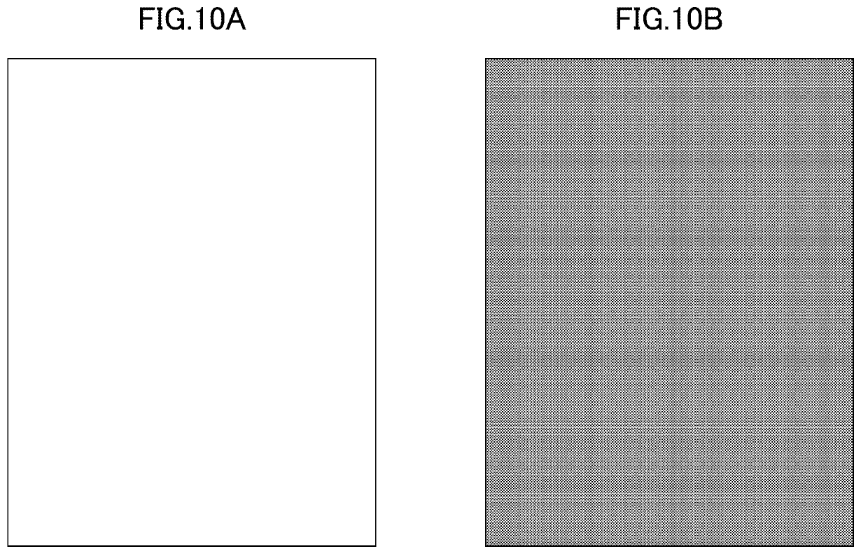

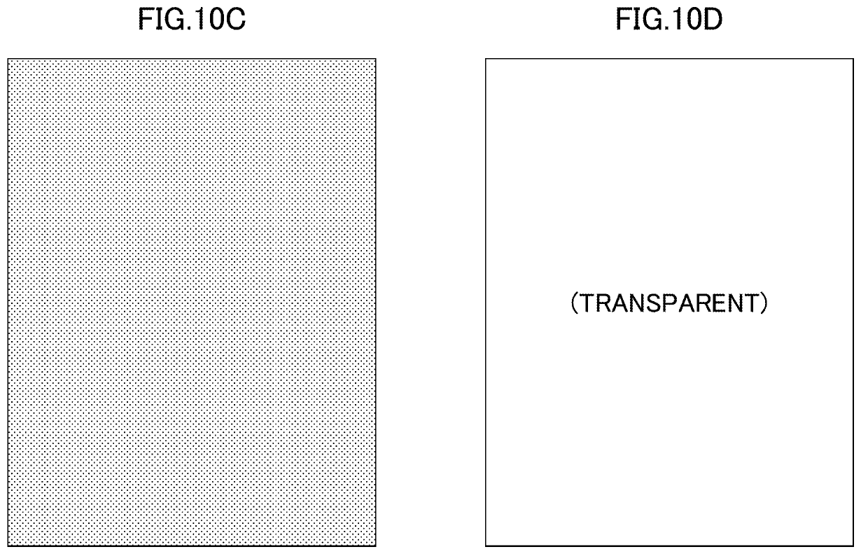

Each of FIGS. 10A to 10D is a diagram illustrating an example of a layout common to all screens.

Options of layouts transmitted to the terminal device 20 at Step S204 described. above include, as layouts common to all screens, for example, a white background as illustrated in FIG. 10A; a dark background as illustrated in FIG. 10B; a bright color background as illustrated in FIG. OC; and a transparent background as illustrated in FIG. 10D.

Note that the transparent background is a background that displays a video captured by a rear camera mounted on the terminal device 20, so as to make the user feel as if the rear is displayed transparently.

The selection logic of layouts that are common to all screens includes, for example, a rule of selecting a transparent background as illustrated in FIG. 10D in the case where a user is on the move (on foot, etc.), because it is safer that the background can be seen.

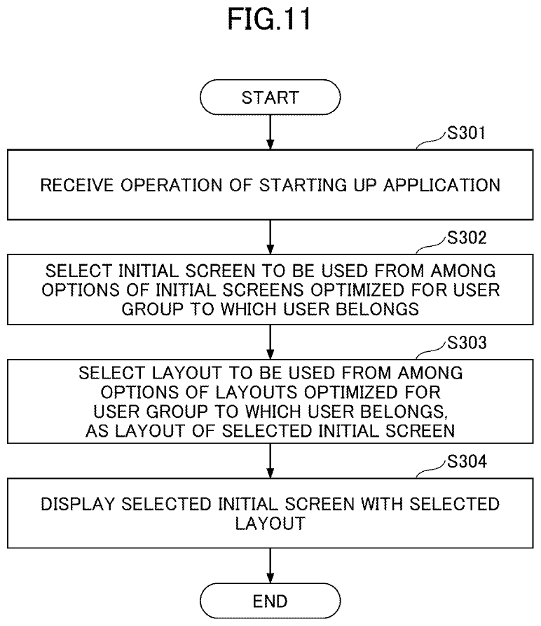

FIG. 11 is a diagram illustrating an example of a flow of an initial screen display process.

The operation receiving unit 23 of the terminal device 20 receives an operation of starting up an application, as an operation performed by the user, at Step S301. Next, the initial screen estimation unit 262 selects an initial screen to be used from among options of initial screens optimized for a user group to which the user belongs, at Step S302.

Specifically, the initial screen estimation unit 262 narrows the initial screens based on the selection logic received from the server device 10, and then, from among these, selects an initial screen to be used for displaying, based on the initial screen learning model 96.

Next, the layout estimation unit 261 selects a layout to be used from among options of layouts optimized for the user group to which the user belongs, as a layout of the selected initial screen, at Step S303.

Specifically, the layout estimation unit 261 narrows layouts of the initial screen selected based on the selection logic received from the server device 10, and then, from among these, selects a layout to be used for displaying, based on the layout learning model 95.

Then, the display unit 27 displays the selected initial screen with the selected layout, at Step S304.

This initial screen display process enables the terminal device 20 to display an initial screen optimized for each user. For example, when started up in weekday nights, a search screen can be displayed from among options of a search screen, a listing screen, a campaign screen, a coupon screen, and an item screen viewed most recently, in the case where the operation log data of an individual user indicates that the search screen has been used most frequently. In this way, the screen selection can take into account tastes that are different for individual users, and hence, it is highly convenient.

Also, by narrowing initial screens or layouts based on the selection logic transmitted from the server device 10, and selecting an initial screen or a layout to be used from among the options that are narrowed, a general rule-based optimization can be combined with an individual user-specific optimization, and thereby, a more practical optimization can be implemented.

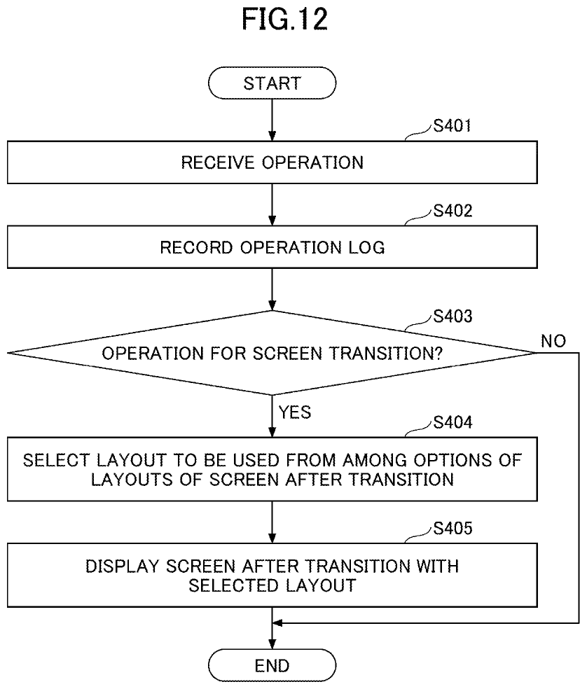

FIG. 12 is a diagram illustrating an example of a flow of an operation receiving process.

The operation receiving unit 23 receives an operation on a screen that is being displayed after activation of the application, at Step S401. The operation receiving unit 23 records the operation in an operation log that represents a history of operations, at Step S402. Specifically, the operation receiving unit 23 stores the operation log data 94 in the storage unit 21.

Next, the operation receiving unit 23 determines whether a received operation is a screen transition operation, at Step S403. Note that the screen transition operation may include operations of screen scrolling, page transition, and the like that change contents such as items to be displayed. If it is determined that the operation is not a screen transition operation (NO at Step S403), the operation receiving unit 23 ends the screen transition process.

If it is determined that the operation is a screen transition operation by the operation receiving unit 23 (YES at Step S403), the layout estimation unit 261 selects a layout to be used from among options of layouts of the screen after transition, at Step S404. The specific selection method is substantially the same as in Step S303 of the initial screen display process.

The display unit 27 displays the screen after transition with the selected layout, at Step S405.

This operation receiving process enables the terminal device 20 to execute displaying with an optimized layout every time the screen transitions, or every time receiving an operation that changes contents of items or the like to be displayed, such as a screen scrolling operation, a page transitioning operation, and the like.

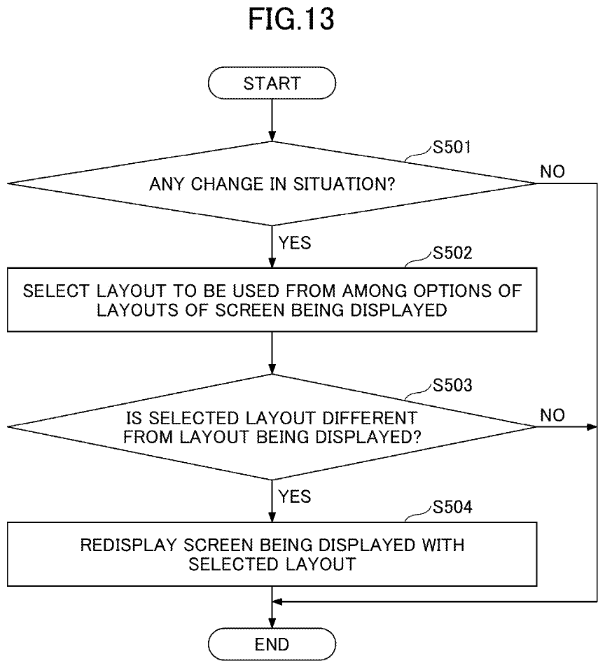

FIG. 13 is a diagram illustrating an example of a flow of a screen layout change process.

The situation detection unit 22 determines whether there is any change in the situation, at Step S501. Specifically, the situation detection unit 22 makes a determination from the situation data, based on conditions that indicate a change in the situation, as in the case of returning home from the outing, or in the case of moving from a bright place to a dark place.

If it is determined that there is no change in the situation (NO at Step S501), the situation detection unit 22 ends the screen layout change process.

If it is determined by the situation detection unit 22 that there is a change in the situation (YES at Step S501), the layout estimation unit 261 selects a layout to be used from among options of layouts of the screen being displayed. The specific selection method is substantially the same as in Step S303 of the initial screen display process or in Step S404 of the screen transition process.

Then, the layout estimation unit 261 determines whether the selected layout is different from the layout being displayed, at Step S503. If it is determined that the selected layout is not different from the layout being displayed (NO at Step S503), the layout estimation unit 261 ends the screen layout change process.

On the other hand, if it is determined by the layout estimation unit 261 that the selected layout is different from the layout being displayed (NO at Step S503), the display unit 27 redisplays the screen being displayed with the selected layout, at Step S504.

This screen layout change process enables the terminal device 20 to execute displaying with a layout in accordance with a change in the situation, without transition of the screen.

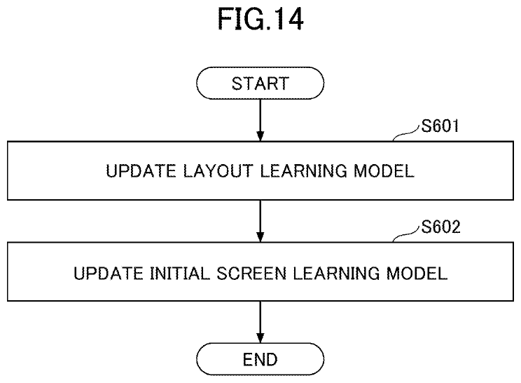

FIG. 14 is a diagram illustrating an example of a flow of a learning process. 1001501 The terminal device 20 executes the learning process regularly, for example, once a day.

The layout learning unit 281 updates the layout learning model 95, at Step S601. Specifically, the layout learning unit 281 estimates correctness of an inference from the contents of operations for a layout displayed as a result of the inference, and reflects the estimation in the layout learning model 95.

The initial screen learning unit 282 updates the initial screen learning model 96, at Step S602. Specifically, the initial screen learning unit 282 estimates correctness of an inference from the contents of operations for an initial screen displayed as a result of the inference, and reflects the estimation in the initial screen learning model 96.

According to the learning process, the terminal device 20 can obtain the layout learning model 95 and the initial screen learning model 96 that are adapted to an individual user, and as a result, the terminal device 20 can provide user interfaces that are adapted to the individual user.

According to the screen display system 1 of the embodiment described above, it becomes possible for the server device 10 to determine options common to users of a user group, and for the terminal device 20 to select an option from among the determined options according to the tastes of an individual user.

For example, in the case where the situation is in early morning of a weekday, and the user is on the move by train,in bright surroundings, and people are around the user, for example, as options common to a user group of “address=Japan”, options of the layout that include “contents that do not present any problem even if seen by others”; “bright screen illumination”; “light motif”; and “large images and characters that are easy to see when even swaying”, can be selected, and an item screen, an item search screen, and the like can be selected as the options of the initial screen. In this case, a layout or an initial screen that includes images and font sizes that match the tastes of an individual user, contents that interest the user, contents that can be seen by others, a method of displaying contents that are not desirable to be seen by others, a method of providing information in accordance with means of transportation, and the like, may be selected.

Also, for example, in the case where the situation is in weekday night, at home without coming and going, in dark surroundings, and no people around the user, for example, as options common to the user group of “address=Japan”, options of the layout that include “all contents”; “normal screen illumination”; “dark motif”; and “displaying necessary and sufficient information” can be selected, and an item screen and a listing screen can be selected as the options of the initial screen. In this case, images and font sizes that match the tastes of an individual user, a method of displaying contents that interest the user or attractive contents, a method of providing information free of boredom, and a layout or an initial screen that leads to item searching and item browsing,may be selected.

Also, for example, in the case where the situation is on weekends or holiday mornings, at home without coming and going, in bright surroundings, and people are around. the user, for example, as options common to the user group of “address=Japan”, options of the layout that include “all contents”; “bright screen illumination”; “light motif”; and “displaying necessary and sufficient information” can be selected, and an item screen and a listing screen can be selected as the options of the initial screen. In this case, images and font sizes that match the tastes of an individual user, a method of displaying contents that interest the user or attractive contents, a method of providing information free of boredom, and a layout or an initial screen that leads to item purchase or listing, may be selected.

In the embodiment described above, as an example of the case where a layout presents contents that can be changed, specifically, in the case where a layout referred to as a layout for item searching while on the move is prepared, and displaying is executed with the layout for item searching while on the move, the search conditions of items may be changed so that items that are specified in advance so as not to be displayed while on the move are not displayed, for items that may preferably he viewed privately.

In this way, the contents to be displayed can be changed depending on individual situations.

Also, the screen display system 1 may display screens other than those for electronic commerce. For example, screens provided for campaigns and coupons may be displayed. In this case, for example, as an option of an initial screen having coupon functions for a user group “occupation=homemaker”, the server device 10 may determine a screen of coupons of a supermarket or a cafe as the option of the initial screen. On the terminal device 20, an optimized initial screen and an optimized layout are selected from among options in accordance with tastes of the user.

The devices described above merely constitute one of multiple computing environments for implementing the embodiments disclosed in the present description. In some embodiments,the server device 10 may include multiple computing devices such as server clusters.

The respective functional units of the embodiments described above may be implemented by one or more processing circuits.

As above, the present inventive concept has been described based on the embodiments; note that the present inventive concept is not limited to the requirements set forth in the above embodiments. These requirements may be changed within a scope within which the gist of the present inventive concept is not lost, and may be suitably specified according to the application.

What is claimed is:

1. A terminal device used by a user, comprising:
a display;
a memory; and
a processor configured to execute:
inferring a layout of a screen optimized for the user, and
displaying the screen with the interred layout on the display.

2. The terminal device as claimed in claim 1, further comprising:
a receiver configured to receive data that represents options of layouts optimized for a user group to which the user belongs, from an information processing device,
wherein the inferring selects the layout optimized for the user from among the options.

3. The terminal device as claimed in claim 2, wherein the processor causes the receiver to further receive data that represents selection logic of the layouts, and
wherein the inferring narrows the options based on the selection logic, to select the layout optimized for the user from among the options that are narrowed.

4. The terminal device as claimed in claim 3, wherein the layouts include layouts common to a plurality of screens, and layouts for each screen, and
wherein the inferring makes a selection from among the layouts common to the plurality of screens and from among the layouts for said each screen.

5. The terminal device as claimed in claim 4, wherein the layouts common to the plurality of screens include a layout presenting a transparent background, and
wherein the selection logic includes a rule of selecting the layout presenting the transparent background while the user is on a move.

6. The terminal device as claimed in claim 2, wherein the processor causes the receiver to further receive data that represents options of the initial screen optimized for the user group, from the information processing device, and
wherein the interring selects the initial screen optimized for the user from among the options, and displays the selected initial screen on the display.

7. The terminal device as claimed in claim 6, wherein the processor causes the receiver to further receive data that represents selection logic of the initial screen, and
wherein the inferring narrows the options based on the selection logic, to select the initial screen optimized for the user from among the options that are narrowed.

8. The terminal device as claimed in claim 6, wherein the data received by the receiver includes, as the options of the initial screen, at least one of a search screen, a campaign screen, a coupon screen, a listing screen, an item screen browsed most recently, a saved search screen, or an electronic settlement screen.

9. The terminal device as claimed in claim 1, wherein the memory stores situation data that represents a situation of the user, and operation log data that represents a history of operations performed by the user, and
wherein the inferring infers the layout, based on the situation data and the operation log data.

10. The terminal device as claimed in claim 9, wherein
the inferring determines whether to change the layout of the screen being displayed on the display, based on a change in the situation of the user represented in the situation data.

11. The terminal device as claimed in claim 1, wherein the layout includes arrangement of at least one of an image of an item, an item name, or a description.

12. A screen display system comprising:
a terminal device including a transmitter, a receiver, a display, a memory, and a processor, and used by a user; and
an information processing device including a receiver, a transmitter, a memory, and a processor, and communicably connected with the terminal device,
wherein the processor of the information processing device executes:
causing the receiver of the information processing device to receive situation data that represents a situation of the user and operation log data that represents a history of operations performed by the user, from the terminal device,
determining an option of a layout optimized for each user group that represents classification of users, and
causing the transmitter of the information processing device to transmit data that represents the determined option, and
wherein the processor of the terminal device executes:
causing the transmitter of the terminal device to transmit the situation data that represents the situation of the user and the operation log data that represents the history of the operations performed by the user, to the information processing device,
causing the receiver of the terminal device to receive data that represents the option, from the information processing device, and
selecting the layout optimized for the user from among the options.

13. A display method executed by a terminal device including a display, a meimry, and a processor, the display method comprising:
inferring a layout of a screen optimized for a user using the terminal device, and
displaying the screen with the inferred layout on the display.
